(19) United States
(12) Patent Application Publication
(10) Pub. No.: US 2005/0120210 A1
(43) Pub. Date: Jun. 2, 2005

(54) Method to minimize software piracy and enhance security in processes related with many industries

(76) Inventor: Hassan Behbehani, Kuwait (KW)

Correspondence Address: Hassan Behbehani, P.O. Box: 1262, Safat, Kuwait, 13013, KW

(21) Appl. No.: 10/939,354

(22) Filed: Sep. 14, 2004

Related U.S. Application Data
(60) Provisional application No. 60/516,277, filed on Nov. 3, 2003.

(51) Int. Cl. H04L 9/00

(52) U.S. Cl. 713/168

(57) ABSTRACT

The presented invention is related particularly with to minimize and even further to block software piracy problems. The invention presented here can work for internet and traditional networking environments as well. The apparatus comprises a server program and client program. The server may be on LAN, WAN, Web or at some remote location. The client program is small program that needs to be embedded in the software that needs to be protected from illegal copies or the software that wants to use the invented process. The client program communicates with server program and receives response from the server. Depending upon the server clients performs certain actions such as allowed to install or to halt the installation. The invention architecture is based on TCP/IP based modeling. I.e. Server acts as TCP server and clients act as TCP clients in order to communicate effectively and reliably. Whenever the process begins, it is added as client on TCP server. The clients sends ID from media to server, server verifies the ID, update the ID and sends back the new ID to client. The client also updates the new ID so that all the copies with previous IDs become ineffective.

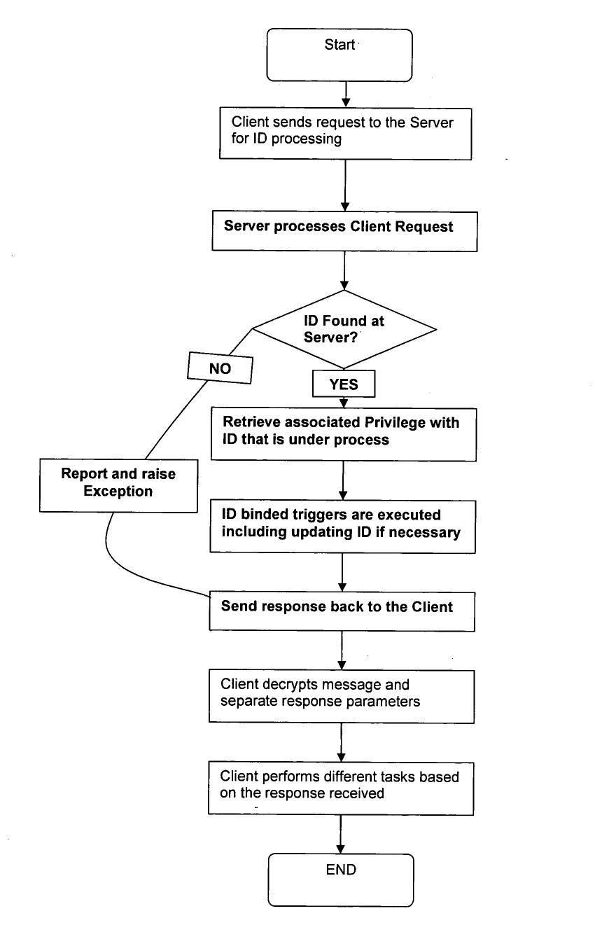

### BACKGROUND OF THE INVENTION

Software piracy is the practice of copying and using a software product without the permission of the owner of the software. Although this is called as information age and most computer users in this era are well aware with the fact that unauthorized use, duplication of software or resale is illegal, many still show a general disregard for treating software as valuable intellectual property.

According to BSA 2001 Report on Global Software Piracy, software accounted for worldwide revenues of $21.6 billion in 2000.

There many ways to conduct this illegal act however some popular categories of software piracy include:

Soft-lifting: This term is used specifically for those people who purchase a single licensed copy of software and load it onto several computers, which is contradiction to license terms. For example, sharing licensed software with friends, co-workers and others.

Software counterfeiting: This is client cheating i.e. selling illegal copies to different people as they were legal.

OEM unbundling: This term is applied when someone tries to sale stand-alone software that was initially accompanied with some hardware.

Uploading and downloading: This is another form of Soft-lifting. Authenticated users make unauthorized copies of licensed software available to them and then conduct the act of soft-lifting.

Hard disk loading: Some dealers install illegal copies of software when someone gets new PC or hardware service from some vendors. Hardware vendors use this technique to promote their business.

Renting: selling of illegal software copies for temporary use, like you would rent a video.

Software pirates can be divided into several categories:

Dealers selling hardware pre-loaded with illegal software

User organizations making unauthorized copies of software for internal use “Professional” software counterfeiters

Competitors using unauthorized software copies to develop competing products Hackers' web sites offering illegal software to users/Individuals who make an unauthorized copy of someone else's software program

The following prior patents represent the state of the art of preventing unauthorized copying of data, and are all hereby incorporated by reference:

U.S. Pat. No. 6,684,199 authenticates at least one of a media and data stored on the media in order to prevent at least one of piracy, unauthorized access and unauthorized copying of the data stored on the media.

U.S. Pat. No. 4,879,704 prohibits optical disc copying. Data is stored into two portions wherein one portion is protected.

U.S. Pat. No. 4,975,898 provides the idea of erasing the non-rewritable portion so that it cannot be copied on a copy disc during unauthorized copying of an optical disc.

U.S. Pat. No. 5,319,735 uses a digital code signal embedded with the original audio signal. The digital code gets transferred to the copy disc.

U.S. Pat. No. 5,412,718 comes up with using non-uniformities and their attributes in the storage medium as a unique signature. This signature is used to derive a key for encrypting the information on the storage medium. During copying, the signature gets mutated and the information cannot be decrypted. During authorized copying, the information is decrypted by generating a key from the signature of the distribution medium.

U.S. Pat. No. 5,418,852 stores the data in a user accessible area and non-accessible area which are both compared to determine the authenticity of the stored medium.

U.S. Pat. No. 5,513,260 protects CDs from copying by recording authenticating signature on them. An authentication signature is obtained by a deliberately induced radial position modulation giving an error voltage corresponding to the elliptical errors. When playing the CD, the signature causes the player to correctly decrypt the program whereas, when playing an unauthorized copy of the CD, the absence of the signature is detected and false data is generated and the player does not play.

U.S. Pat. No. 5,538,773 discloses the recording of data together with cipher key information for copy protection.

U.S. Pat. No. 5,570,339 discloses a system that converts data to digital data, that data is then FM modulated with key information to vary the widths of the pits at the recording time. The data is again read out at the time of reproduction and copying is prevented if key information is missing.

U.S. Pat. No. 5,636,276 discloses the distribution of digital music with copyright protection. An encryption table is embedded in the music CD player and includes a decryption module that uses the encryption table for authorized playing of music/information.

The problem with one or more of the above-mentioned conventional encryption/decryption systems is that a pirate or hacker seeking to hack into the encryption process on a disc could do so by finding the encryption key, which is buried, mixed and interleaved with the data, and using that key to decrypt the data on the disc.

In other words, accompaniment of the any decryption key or identification key within the data lends itself to discovery, even if the data is in an encrypted form.

An additional problem in one or more of the prior art references is that keys specific to, or derived from, the physical construction of the CD are not constructed or determined in a manner that is difficult to detect by a hacker. A further problem in the prior art is that the physical characteristics of the CD which are used to derive a key for authorized copying, are transferred in the data and may be accessible to the hacker.

Most of the patents described are addressing towards the same issue by having the similar root ways i.e. by forming a key through some technique. And in some cases CDs are totally prevented from being copied which as inconvenient as in business situations it is highly required to do copy and use the data. The second reason is that if key is uniform and copy is allowed then all the copies will work. This problem raised the need for mediate way that not only provides copying but also do an effective authorization. To become the piracy problems, I have invented mechanism that uses the same root methodology as the conventional system but different is that key embedded is updated both on the client and server every time whenever data is used. This updatable key concept is the core of the presented invention.

The presented invention is designed specifically to address the above software piracy techniques and problems in the existing techniques. The said invention minimizes the risks that are associated with big business groups of loosing a huge amount of their wealth regarding software piracy. Though invention is effectively designed to solve the piracy problems but it can also be used in different business situations where security is crucial and authorization based model is in place in any process.

The said invention is blessing for big companies who are in the software business or for resellers of software products. These companies distribute their products on different media including CDs, DVDs . . . etc; the presented invention can effectively minimize the piracy risk. Even once copy has been used then still further illegal copies will not work because once a copy is used, the attached ID both on the server and copy are updated. The only associated risk is that if copy is stolen and used then owner will not able to use original copy. The presented invention can also be used effectively to protect space channels from unprivileged access, and for financial transactions and processing through smart cards or in form of any other way. The invention may also be helpful for different industries in sort of software or firmware.

### BRIEF SUMMARY OF THE INVENTION

The presented invention is related particularly with to minimize and even further to block software piracy. The apparatus necessary consists of server program which holds the ID of each copy of software to be installed. The ID of each copy is embedded in the software program/package that needs to be installed.

When the process starts it reads the data from said media i.e. from CD ROM, hard Disk, Magnetic Diskette . . . etc. The process detects the unique authentication ID from the data on the said media. After finding the unique ID a connection is established with the server in order to verify the unique ID. If connection is established the client automatically encrypts the unique ID identified in the software and sends it to the server. The server receives the ID and decrypts it. Once server has decrypted the unique ID, it tries to find the similar ID on the server itself. If this ID is found then server extracts the attached attribute with this ID. Whenever ID is created on the server, default tag of “Allow” is attached with new ID so that new IDs are allowed to proceed. Once ID has been used by default a “Block” tag is attached means that this ID has been already used and any software accessing the server with this ID is not allowed. After identifying the ID on the server and extracting the attached attribute if allowed are encrypted and sent back to the client. The client receives the information, decrypts it and begins the process. After finishing the process successfully, client update the existing ID with new ID received from the server and sends acknowledgement to the server. When acknowledgement from the client at server side is received, these changes are committed at the server. The server automatically discards the changes if any of the disconnection takes place or acknowledgement from the client is not received.

The only provision to implement this technology is to distribute the software through write-able media such as rewriteable CDs . . . etc.

There has thus been outlined, rather broadly, the important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the software installation and distribution only. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be used as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the abstract is to enable the U.S. Patent and Trademark Office and the public generally, and especially scientists, engineers and practitioners in the art, who are not familiar with patent or legal terms or phraseology, to determine quickly from a cursory inspection, the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

There one drawing comprising the working of presented invention. The drawing is a flowchart of the overall process of the invention. All the symbols used are the standard symbols used in flowcharts otherwise stated. The Bold text is of server side processing while the Normal text shows client side processing.

Sheet 1: Technical flow of presented invention.

### DETAILED DESCRIPTION OF THE INVENTION

The invention presented here reveals a process to minimize the software piracy risks. As described earlier Software piracy is the practice of copying and using a software product without the permission of its owner or developer. Although most users including small to big companies today are well aware that unauthorized use and software duplication is illegal, many still show a general disregard for treating software as valuable intellectual property. According to different reports and research, software industry is loosing billion of dollars due to software piracy therefore there is an urgency to control this illegal act with some realistic and flexible approach.

Currently there are various techniques to minimize the software piracy but no technique is much effective. One popular way is to generate some IDs and embed these IDs in the CD but still people can install software illegally by copying the CD because ID is already known.

In one technique software key is put into the registry and this key is compared with user provided key but hackers are still there to tackle this problem. Another way is to download the software from web after authentication and then install it. This is also gap in this method once the software is downloaded then it can be copied and installed without any major problem. Further from these copies again many copies can be created and so on thus every copy is fatal and can be used for further piracy.

The presented invention comes up with rather different technique developed on the core concept of IDS and then authenticates these IDS. The phase where the invention differs is the updateable IDs. Whenever a software on CD is used, the ID is updated on both sides i.e. client and server. Thus if someone has copied the media, it will not work because ID at the server has been updated.

The presented invention requires simple software program to be resided on the server for the IDs management. This program is responsible for adding, editing and deleting the IDs from the central server. The said program also has the facility to embed the generated IDs into data on other media. The server may be a web server, LAN server or some remote server for IDs management.

The software program that resides on server can use any relational database or other kind of repository for IDs management or can make effectively a document comprising the IDs enlisting of each copy of software. The server sides created lists are needed to be interactive with client based software to be installed. The management of these lists is automatic and may be manual as well. The manual management can be done after having access and authentication on the server.

The software program that resides on server effectively implements the IDs lists. Whenever a copy of software is distributed, a key is embedded into the software to be installed and on server as well. Each ID is then associated with privileges by the administrator of the software running on the server side. These privileges are set by default and are changeable by the administrator of the server side program. These privileges include Allow, Deny or report or some other such as Block. The associated set of privileges with each copy of client software is triggered whenever a certain copy of the client software is installed and therefore tries to access a certain ID on the server side.

There is default values set for each newly added ID on the server side repository of ID lists. Whenever a new ID is created on the server, it has the privilege Allow; it means any request coming through this ID will be allowed to proceed. In case of updating of any existing ID, the new updated ID will be tagged with “Allow” while the previous ID which has been updated will be tagged with “Deny” or “Block” so that no copy goes through the previous ID. This scenario is particularly useful if someone has copied the original software and tries to access after actual owner has accessed the ID. This scenario is also helpful in the case if the original copy has been stolen. The administrator can block any copy and all the IDs generated by the original copy whenever it is reported about the theft or loss of media having the software.

The privileges set are also customizable. It can have more values than Allow, Deny and Report. The privileges set are defined by the administrator. The actual action associated with each privilege is also defined by the customer. For example, Administrator may choose to email some person such as piracy controller in case copy tries to access the ID that has associated privilege “Report”. Multiple triggers can also be invoked on certain events. For example, Administrator may choose to block all the copies with privilege set as “Report” and can also send an email automatically whenever any copy tries to access the server through ID which is marked as “Report”

The process of setting privileges is really helpful if someone has stolen the original copy and accesses the ID before the actual owner. In this case, Owner copy will not be installed or owner process will not be executed and this is also as intimation for the owner regarding the theft. The owner can report and thus the one who has stolen the copy will have no further access under this ID. So again presented invention is big help in minimizing the piracy and discouraging the copying process because whenever a copy is used, all the other copies become ineffective automatically due to updating ID to new ID in both client and server and blocking the original IDs. As described earlier, the presented invention requires an ID management program on the server side; a simple mechanism similarly is executed inside the software copy which is going to be installed. The ID embedded in the client software is also updated after IDs on the both sides have been matched and there is attached privilege as “Allow” or any other tag that has been decided by the administrator of the server side software.

When the installation process begins or any other process which is using this presented invention, there is initially a hidden (recommended way of embedding ID into software) or visible and encrypted ID embedded or packaged in the client software. The copy which is being under the process may reside on any media including but not limited to CD, Disk Storage, Floppy Diskette, magnetic tape or any other writeable storage media.

The only provision to use the said invention is that it requires writeable media so it is required that if software is distributed in form of CDs then these CDs should be writeable which effectively requires to use the CDs through CD writer. If media is not writeable then process raises the exceptions and takes appropriate action and instructions to solve the issue. For example, if software is distributed in read only CDs or client does not have CD writer then software can be copied from CD to hard disk with write permissions in order to execute the process. The client later can update his copy by copying back the software from CD to hard disk because original software does not work as IDs both on client and server have been updated that is core purpose of the said invention.

Before initiating the actual process of installation or any other specific process which has been set under the said invention, a trigger is invoked automatically to retrieve the ID embedded in the software. This ID is send to server for processing and retrieving the attached privilege set.

When any of the ID is received at server side, server processes this ID and sends the response back to the client. The server first checks weather the existing ID is present on the server or not. Once it finds that specific ID, server retrieves the associated privilege set. According to the set triggers, server executes the triggers that may include updating of existing ID or adding another ID associated with each copy and sends the response back to the client. In simple words, these triggers are actually events that are bound to be invoked automatically on server side. This also includes updating of ID i.e. ID updation is conditional. For example, if privilege is “Allow” server updates the privilege of existing ID as “Deny” or “Report” and adds another ID under the same copy ID hierarchy and sets its privilege as “Allow. The newly added ID is sent back in response so that the newly added ID on server side can replace the existing ID in client side embedded in the software itself.

The response data is variable in many aspects and depends on may factors. For example If both the IDs are the same and there is “Allow” tag associated with the ID, the response also includes the new encrypted ID after updating the existing ID along with the other messages such as “Proceed”. However the updated ID is not always included in the response. The conditions in which response includes a new ID depends upon the administrator. Administrators are allowed to define conditions, privileges and can assemble associated triggers.

After server side has finished and response has been send back to client software, client begins its process. First of all, response is translated and decrypted, Updated ID is decrypted and appropriate action is taken as suggested by the server in its response. For example if new ID is present in the response received at the client side, the existing copy ID in the client side is replaced with the ID received in the response from the server. This is done because the same copy is processed with new updated ID and privilege associated with old ID at the server side is changed automatically according to the conditions set by the administrator. However again this can be done manually as well by the administrator of the server side program.

Now client software is allowed to install or stopped or any further action is taken depending upon the response. For example, server sends response to the client like “Allow:Message:Updated ID”. This messages means that Client should proceed, replace its existing ID with the updated ID and show this message to the user if there is any. The presented invention uses the format as “Privilege: Message: ID”

Privilege: The client decrypts the response from server, separates this parameter and takes the further action depending upon this parameter.

Message: The client decrypts the response from the server and this message is presented stating what has been done. For example, you have been authenticated and allowed to proceed. This parameter is optional and is not returned always. This is returned according to the conditions set by the administrator.

ID: This is unique ID that is automatically updated according to algorithm on server side. This ID can be up to any length and can be in any format. This parameter is optional parameter and is not always returned. This parameter is returned under the conditions and privileges associated with the client copy ID defined by the administrator. By default is returned when there is “Allow” privilege is in the place associated with the client ID.

When the process starts it reads the data from said media i.e. from CD ROM, hard Disk, Magnetic Diskette . . . etc. The process detects the unique authentication ID from the data on the said media. After finding the unique ID a connection is established with the server in order to verify the unique ID. If connection is established the client automatically encrypts the unique ID identified in the software and sends it to the server. The server receives the ID and decrypts it. Once server has decrypted the unique ID, it tries to find the similar ID on the server itself. If this ID is found then server extracts the attached attribute with this ID. Whenever ID is created on the server, default tag of “Allow” is attached with new ID so that new IDs are allowed to proceed. Once ID has been used by default a “Block” tag is attached means that this ID has been already used and any software accessing the server with this ID is not allowed. After identifying the ID on the server and extracting the attached attribute if allowed are encrypted and sent back to the client. The client receives the information, decrypts it and begins the process. After finishing the process successfully, client update the existing ID with new ID received from the server and sends acknowledgement to the server. When acknowledgement from the client at server side is received, these changes are committed at the server. The server automatically discards the changes if any of the disconnection takes place or acknowledgement from the client is not received.

1. A method for authenticating data stored on said media in order to minimize piracy, unauthorized access of the data stored on said media, comprises the steps of:
reading the data from said media;
detecting the unique authentication ID from the data on the said media;
making the connection with the server
encrypting the unique ID
sending the encrypted unique ID identified in detecting the unique step from client to server
identifying the same authentication ID on the server after decrypting unique ID as sent by the client;
reading the attached attribute information with the ID identified on the server;
identifying weather the attribute allows the data on media to proceed. If it is allowed then update the ID on the server;
encrypting the unique ID and attribute information as identified in above step;
returning the encrypted attribute information and encrypted new updated ID in encrypting form on the server back to the client;
decrypting unique ID and attribute information sent by the server to client at client side;
updating the unique authentication ID with the ID sent by the server at client side;
taking action according to the received attribute information from the server;
updating the action fields
media means the source of data such as hard disk, floppy diskette, CD ROM, DVD ROM, temporary computer storage, smart card . . . etc.
attribute information means the type of authorization, the attached unique ID has on the server, It may be BLOCK, ALLOW . . . etc.
action fields means the fields that are kept on server side for reporting and information purposes such as number of used specific id chain . . . etc.

2. A method as claimed in claim 1, wherein the said method is halted if no unique ID is the specified format is found on the said media

3. A method as claimed in claim 1, wherein the said method monitors the connectivity and communication between client and server and provides necessary error handling

4. A method as claimed in claim 1, wherein the said method provides error handling if the client unique ID does not exists on the server

5. A method as claimed in claim 1, wherein the said method provides exception handling if the source media is not writeable

6. A method as claimed in claim 1, where in server changes the attribute information associated with unique ID after updating the unique ID to new ID according to specified attribute information.

7. A method as claimed in claim 1 wherein said method client signal server about the successful completion of the said method

8. A method as claimed in claim 7, wherein server signal the client and gives the receipt back to the client for receiving signal

9. A method as claimed in claim 8, wherein the changes on the server rolled back if client does not signal the server for method completion

10. A method as claimed in claim 1 wherein the said method roll back the changes made in unique ID on server if any exception is raised and method is not completed before updating the ID on the client side as well

11. A method as claimed in claim 1, wherein the said method comprising a scheme to generate and manage unique IDs on the server.

12. A method as claimed in claim 1, wherein the said method comprising a tool to transfer data on media embedding a unique ID inside media.
media means the source of data such as hard disk, floppy diskette, CD ROM, DVD ROM, temporary computer storage, smart card . . . etc.

13. A method as claimed in claim 1 wherein the data transfer in the said method between client and server is encrypted.

14. A method as claimed in claim 1, wherein any data is transferred from client to server or server to client is decrypted after receiving the data in order to make it understandable for the client or the server

15. A method as claimed in claim 1 wherein the said method is for use in a communications network having a server and clients linked by a data network.

16. method as claimed in claim 1 wherein the said method is for use in a communications network having a server and clients linked by a data network supporting World Wide Web (Web) communications

17. A method as claimed in claim 1 wherein the said method is for use in a communications network having a server and clients linked by a data network

18. A method as claimed in claim 1 wherein the said method is for use on a computer having server and client both on the computer supporting World Wide Web (Web) communications

19. A server for use in method as claimed in claim 1, in a data network supporting World Wide Web (Web) communications wherein the said server performing the following tasks;
generating unique IDs
editing and deleting unique IDs
generating attribute information
allowing the attachment of attribute information with unique IDs
editing and deleting the existing attributes
editing the relationships between unique IDs and attribute information
allowing the deletion of attached attribute information with unique IDs
media means the source of data such as hard disk, floppy diskette, CD ROM, DVD ROM, temporary computer storage, smart card . . . etc.
attribute information means the type of authorization, the attached unique ID has on the server, it may be BLOCK, ALLOW . . . etc.

20. A tool for managing the operations performed by server as claimed in claim 19, wherein the said tool allows the authorized entities to manage the said operations.

21. A client for use in method as claimed in claim 1, in a data network supporting World Wide Web (Web) communications wherein the said client comprising the data on source media with embedded unique ID that will be updated later.
media means the source of data such as hard disk, floppy diskette, CD ROM, DVD ROM, temporary computer storage, smart card . . . etc.
attribute information means the type of authorization, the attached unique ID has on the server, it may be BLOCK, ALLOW . . . etc.
